(19) United States
(12) Patent Application Publication
(10) Pub. No.: US 2010/0146029 A1
(43) Pub. Date: Jun. 10, 2010

(54) METHOD AND APPARATUS FOR MODULAR OPERATION

(75) Inventor: Kunihiko HIGASHI, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kanagawa (JP)

(21) Appl. No.: 12/634,157

(22) Filed: Dec. 9, 2009

(30) Foreign Application Priority Data
Dec. 9, 2008 (JP) 2008-313112

(51) Int. Cl. G06F 7/72; H04L 9/28

(52) U.S. Cl. 708/491; 380/28

(57) ABSTRACT

The modular operation apparatus of the present invention that enables to improve the tamper resistance to the side channel attacks includes an operator that carries out a Montgomery multiplication according to one of a first multiplicand and a second multiplicand, a multiplier, and a divisor, a first multiplicand register that stores an operation result of the Montgomery multiplication as the first multiplicand, a subtractor that subtracts the divisor from the operation result of the Montgomery multiplication, a second multiplicand register that stores a subtraction result of the subtractor as the second multiplicand, and a selector that outputs one of a value of the first multiplicand register and a value of the second multiplicand register according to a comparison result between the operation result of the Montgomery multiplication and the divisor.

### BACKGROUND

1. Field of the Invention

The present invention relates to a modular operation apparatus provided with a modular operation function, and particularly to a technique effective for encrypting and decrypting by a Montgomery multiplier.

2. Description of Related Art

A cryptographic algorithm is used in various information equipments from the need to improve security in a ubiquitous network society that anyone can access information anywhere at any time. In connection with this, research and development for the cryptographic algorithm and implementation with better efficiency are progressing. However, while the cryptographic algorithm is actively studied and developed, studies and researches for vulnerability in the cryptographic algorithm and an implementation of the cryptographic algorithm are also active. The research for the side channel attack, which is an attack on the implementation, is receiving considerable publicity in academic conferences, especially in recent years.

The side channel attack is an attack attempting to obtain internal confidential information from side channel information such as power consumption, electromagnetic wave, processing time during processes or the like other than original communication paths (channels). Timing analysis is one method of the side channel attacks. This method focuses attention on the point that the processing time differs depending on the value to calculate in order to derive the internal confidential information.

When an algorithm is vulnerably implemented, such as RSA (Rivest-Shamir-Adleman)™ method which is generally recognized as a secure algorithm that uses a modular exponentiation operation, a secret key may easily be guessed by the side channel attack (especially timing analysis). That is, not only a safe cryptographic algorithm but a safe implementation of the cryptographic algorithm is required. In order to realize a safe implementation, a tamper resistance of the implementation circuit must be improved.

The modular exponentiation operation is used for the calculation of encrypting and decrypting process of a public key cryptosystem explained below, for example. The RSA™ method is mainly used at the moment for public key cryptosystem. The RSA method is a cryptosystem that utilizes the difficulty in the factorization into prime factors of the number N, which is a product of two arbitrary prime numbers, and also utilizes various different features of an algebraic number modulo N. Modular exponentiation operations (M^{e} mod N) are implemented for encryption and decryption.

The modular exponentiation operation is usually transposed to a repetition process of the following modular multiplication operation.

For example, when e=19

$$\begin{matrix}e = 19 = 1 + 2 \times ( 1 + 2 \times ( 0 + 2 \times ( 0 + 2 \times 1 ) ) ) , & \\ \begin{matrix}C = {M}^{e} mod N \\ = {M}^{19} mod N \\ = {M}^{( 1 + 2 \times ( 1 + 2 \times ( 0 + 2 \times ( 0 + 2 \times 1 ) ) ) )} mod N \\ {= {( {( {( {M}^{1} )}^{2} \times {M}^{0} )}^{2} \times {M}^{0} )}^{2} \times {M}^{1} )}^{2} \times {M}^{1} mod N \\ = {( {( {( {M}^{2} )}^{2} )}^{2} \times M )}^{2} \times M mod N\end{matrix} & \end{matrix}$$

By decomposing the exponent e as above, the count of multiplication can be reduced more than when simply multiplying M for e−1 times, and thereby reducing the operation time. Note that the above decomposition method of the exponent e is called binary exponentiation, and is a general decomposition method of e.

However, in the above modular multiplication operation, the number of digits in the operation doubles by the multiplication, and the multiplication result is divided by N, thus it is difficult to effectively process either by hardware or software. Therefore, an operation method that uses an algorithm called Montgomery multiplication is known as a method to increase the efficiency of a modular multiplication operation.

FIG. 5 depicts the Montgomery multiplication algorithm (S=P(AB)_{N}=AB×2⁻ⁿ mod N). FIG. 6 depicts the modular exponentiation operation algorithm (in the case of C=M¹⁹ mod N). When the Montgomery multiplication algorithm of FIG. 5 is applied to the modular exponentiation operation algorithm of FIG. 6, the above modular exponentiation operation can be processed without requiring an actual division.

C=M¹⁹ mod N=(((M²)²)²×M)²×M mod N

The above C can be calculated as indicated in FIG. 6. The modular exponentiation operation algorithm of FIG. 6 is explained hereinafter along with the numerals in FIG. 6.

First, prior calculation of (1) is carried out, then as in (2) to (7), Montgomery multiplication of a multiplication and a square operation are repeated according to the decomposed number e, and in the last Montgomery multiplication of (8), 1 is multiplied to remove 2ⁿ to calculate C.

In the computation example of a modular exponentiation operation of FIG. 6, as the exponent is e=19, 8 Montgomery multiplications are required to calculate. However, in the case of RSA1024 (key length 1024 bits) which is a widely used RSA™, C/M/N/e is 1024 bits. Thus according to the abovementioned decomposition method of the exponent, 1536 Montgomery multiplications in average are repeated.

As explained above, the modular exponentiation operation usually uses the Montgomery multiplication (A×B×2⁻ⁿ mod N and A²×2⁻ⁿ mod N) to repeatedly calculate.

One of main features of the Montgomery multiplication is that it is possible to calculate without substantial division. An operation result S of the Montgomery multiplication 0<=S<2N, as illustrated in (f) of the Montgomery multiplication algorithm of FIG. 5, and may exceed the value of N depending on the value of A/B/N. If the operation result S exceeds the value of N in (t) of the Montgomery multiplication algorithm of FIG. 5, a subtraction S−N is performed and the operation result must be corrected (reduced).

FIG. 7 is a block diagram illustrating a modular operation apparatus of the Montgomery multiplication according to a prior art (Japanese Unexamined Patent Application Publication No. 10-21057). A modular operation apparatus illustrated in FIG. 7 includes registers 18 to 20 that hold a multiplicand A, a multiplier B, and a divisor N, a control register 17 that specifies a Montgomery multiplication with a different multiplier, a selector 16 to correspond to the Montgomery multiplication specified by the control register 17, an operator 15, and a bus 12.

In the prior art, the modular operation apparatus illustrated in FIG. 7 processes a Montgomery multiplication, and to process a modular exponentiation operation, the modular operation apparatus repeats the Montgomery multiplication according to the modular exponentiation operation algorithm of FIG. 6. That is, the modular operation apparatus illustrated in FIG. 7 calculates M′ using the modular exponentiation operation algorithm of FIG. 6, uses M′ as initial values of A and B, which are to be input to the operator 15, repeats the Montgomery multiplication process flow of FIG. 8 according to the exponent e decomposed as in (2) to (7) of the modular exponentiation operation algorithm of FIG. 6, and lastly removes 2ⁿ in (8) of the modular exponentiation operation algorithm of FIG. 6, so as to process the modular exponentiation operation.

The abovementioned Montgomery multiplication process flow is explained hereinafter. FIG. 8 illustrates a process flow of the Montgomery multiplication performed by the modular operation apparatus in FIG. 7. First, a repeating operation of the Montgomery multiplication in S111 is started according to the decomposed exponent. However, it is A=B=M′ as described above. In S112, the Montgomery multiplication and a comparison of the operation results S and N are performed. Then the result of the Montgomery multiplication is held in the register 18 of FIG. 7, and the result of the comparison is held in the operator 15 of FIG. 7. The comparison is performed inside the operator 15 of FIG. 7. Next, in S113, it is determined whether to perform a reduction (S=S−N) or not depending on the above comparison result between the operation results S and N. If the reduction is not performed, the value of S held in the register 18 of FIG. 7 in S114 is used as S as is. If the reduction is performed, the reduction process of S−N is performed inside the operator 15 of FIG. 7 in S115, and the result S is rewritten and held in the register 18 of FIG. 7.

Next, in S116, it is determined whether to continue repeating the Montgomery multiplication according to the decomposed exponent. If all the Montgomery multiplications are completed according to the decomposed exponent, the process proceeds to “Complete repeating operation of Montgomery multiplication” in S120. If the Montgomery multiplication is continued to repeat, in S117, the decomposed exponent is referred to determine whether the next Montgomery multiplication is a multiplication or a square operation. If the next Montgomery multiplication is a square operation, in S118, it is A=B=S. If the next Montgomery multiplication is a multiplication, in S119, it is A=S. Then the process proceeds to the Montgomery multiplication and the comparison between the operation results S and N in S112.

FIG. 9 is a timing chart illustrating a part of a process operation of the modular exponentiation operation according to the modular operation apparatus in FIG. 7. In the related art explained above, as illustrated in FIG. 9, in the repeatedly performed Montgomery multiplication, the Montgomery multiplication result S may be larger or smaller than N depending on the values of the multiplicand A, the multiplier B, and the divisor N in the Montgomery multiplication, thus the reduction is generated at random. In the repeatedly performed Montgomery multiplication, by repeating the reduction generated at random, the processing time of the whole modular exponentiation operation increases. Therefore, in order to prevent from increasing the processing time of the whole modular exponentiation operation, the related art makes an effort to reduce the frequency of the occurrence of reduction.

Furthermore, in order to carry out a modular calculation with a smaller circuit at a higher speed, for signed binaries A and B, Japanese Unexamined Patent Application Publication No. 2007-34038 discloses a technique to compare the operation result A−B and A as unsigned binaries, and selectively outputs the smaller one.

### SUMMARY

In the related art, as illustrated in FIG. 9, the reduction is determined to be performed or not depending on the operation result of the repeatedly performed Montgomery multiplication. This reduction is a process necessary to obtain the normal Montgomery multiplication result. However, there is a possibility that the process of the reduction may lead to leak a secret key, which is confidential information. That is, the present inventor has found a problem that the abovementioned timing analysis, which is one of the side channel attacks, enables to easily guess whether the reduction is performed or not and this is a clue that helps to guess the secret key, which is confidential information, as a result.

To explain with RSA™ method, an exponent value (for example the abovementioned e) at the time of decrypting is a secret key, and it must be confidential to the others. However the secret key may leak by the abovementioned timing analysis. The reason for such situation to occur is that it is unable to determine whether a reduction is required or not unless a Montgomery multiplication is completed. That is, in the related art, as illustrated in FIG. 9, the reduction of S115 in FIG. 8 is performed after completing the Montgomery multiplication. The reduction after completing the Montgomery multiplication is the reason to deteriorate the resistance to the side channel attack.

An exemplary aspect of an embodiment of the present invention is a modular operation apparatus that includes an operator that carries out a Montgomery multiplication according to one of a first multiplicand and a second multiplicand, a multiplier, and a divisor, a first multiplicand register that stores an operation result of the Montgomery multiplication as the first multiplicand, a subtractor that subtracts the divisor from the operation result of the Montgomery multiplication, a second multiplicand register that stores a subtraction result of the subtractor as the second multiplicand, and a selector that outputs one of a value of the first multiplicand register and a value of the second multiplicand register according to a comparison result between the operation result of the Montgomery multiplication and the divisor.

This configuration enables to force a reduction during the operation of a Montgomery multiplication, hold both values before and after the reduction, and select one of these values. Thus the reduction period can be made invisible apparently. The apparent invisible of the reduction period improves the tamper resistance to the side channel attack.

Another exemplary aspect of an embodiment of the present invention is a method of modular operation that includes carrying out a Montgomery multiplication according to a multiplicand, a multiplier, and a divisor, storing an operation result of the Montgomery multiplication as a first multiplicand, subtracting the divisor from the operation result of the Montgomery multiplication, and storing a subtraction result as a second multiplicand, selecting one of a value of the first multiplicand register and a value of the second multiplicand register according to a comparison result between the operation result of the Montgomery multiplication and the divisor, and carrying out a Montgomery multiplicand according to the selected multiplicand, the multiplier, and the divisor.

This modular operation method enables to force a reduction during the operation of the Montgomery multiplication, hold both values before and after the reduction, and select one of these values, thereby making the reduction period invisible apparently. Making the reduction period invisible apparently improves the tamper resistance to the side channel attacks.

The present invention enables to improve the tamper resistance to the side channel attack to the modular operation apparatus.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram of a modular operation apparatus according to an embodiment of the present invention;

FIG. 2 illustrates a process flow of a Montgomery multiplication according to the embodiment of the present invention;

FIG. 3 illustrates a timing chart of the Montgomery multiplication according to the embodiment of the present invention;

FIG. 4 illustrates a timing chart of a part of a process operation of a modular exponentiation operation according to the embodiment of the present invention;

FIG. 5 illustrates a Montgomery multiplication algorithm;

FIG. 6 illustrates a modular exponentiation operation algorithm;

FIG. 7 is a block diagram of a modular operation apparatus according to a prior art;

FIG. 8 illustrates a process flow of Montgomery multiplication performed by the modular operation apparatus in FIG. 7; and

FIG. 9 illustrates timings of a part of a process operation of the modular exponentiation operation according to the modular operation apparatus in FIG. 7.

### DETAILED DESCRIPTION OF THE EXEMPLARY EMBODIMENTS

Hereafter, an exemplary embodiment of the present invention is described with reference to the drawings.

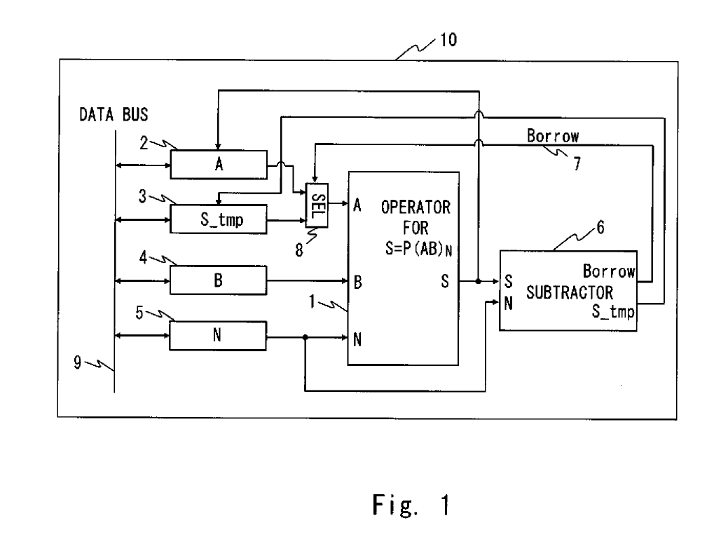

FIG. 1 is a block diagram illustrating a modular operation apparatus according to the embodiment of the present invention.

A modular operation apparatus 10 includes an operator 1 that performs a Montgomery multiplication based on one of a first multiplicand and a second multiplicand, a multiplier, and a divisor, a first multiplicand register 2 that stores the operation result of the Montgomery multiplication as the first multiplicand, and a subtractor 6 that subtracts the divisor from operation result of the Montgomery multiplication. The modular operation apparatus further includes a second multiplicand register 3 that stores the subtraction result of the subtractor 6 as the second multiplicand, and a selector 8 that outputs either the value of the first multiplicand register or the value of the second multiplicand register to the operator 1 according to the comparison result between the operation result of the Montgomery multiplication and the divisor.

To be more specific, the modular operation apparatus 10 includes the operator 1 that calculates S=P(AB)_{N} before reduction and outputs an operation result S, the first multiplicand register 2 (hereinafter also referred to as a multiplicand A register) that stores a multiplicand A, the second multiplicand register 3 (hereinafter also referred to as a multiplicand S_tmp register) that similarly stores a multiplicand S_tmp, a multiplier register 4 that stores a multiplier B, and a divisor register 5 that stores a divisor N. The modular operation apparatus 10 further includes the subtractor 6 that performs S_tmp=S−N and outputs the subtraction result Strap, and the selector 8 that selects an output from the multiplicand A register 2 if a borrow signal 7 is “1” and selects an output of the multiplicand S_tmp register 3 if the borrow signal 7 is “0”.

An output signal of the selector 8 is connected to an A input of the operator 1, an output signal of the multiplier B register 4 is connected to a B input of the operator 1, and an output signal of the divisor N register 5 is connected to an N input of the operator 1. An S output of the operator 1 outputs the operation result S from the lower bit side in a time-sharing manner by each bit length S.

The S output of the operator 1 is connected to an S input of the subtractor 6, and the output signal of the divisor N register 5 is connected to the N input. From the subtraction result of S-N, the subtractor 6 sets the borrow signal to “1” if S<N, and sets the borrow signal to “0” in other cases. The borrow signal 7 is output to the selector 8. An S_tmp output of the subtractor 6 outputs a subtraction result S_tmp from a lower bit side in a time-sharing manner by a certain bit length.

The multiplicand A register 2 has a function to write or read data from a CPU via a data bus 9, and to write the output S of the operator 1. Further, the multiplicand A register 2 outputs the holding data to the operator 1 via the selector 8 in a time-sharing manner by a certain bit length.

The multiplicand S_tmp register 3 has a function to write or read data from a CPU via a data bus 9 and also writes the output S_tmp of the subtractor 6. Further, the multiplicand S_tmp register 3 outputs the holding data to the operator 1 via the selector 8 in a time-sharing manner by a certain bit length from the lower bit side.

The multiplier B register 4 and the divisor N register 5 have a function to write and read data from the CPU via the database 9.

The selector 8 inputs the borrow signal 7, and outputs to the operator 1 either the value of the multiplicand A register 2 or the value of the multiplicand S_tmp register 3 according to the borrow signal.

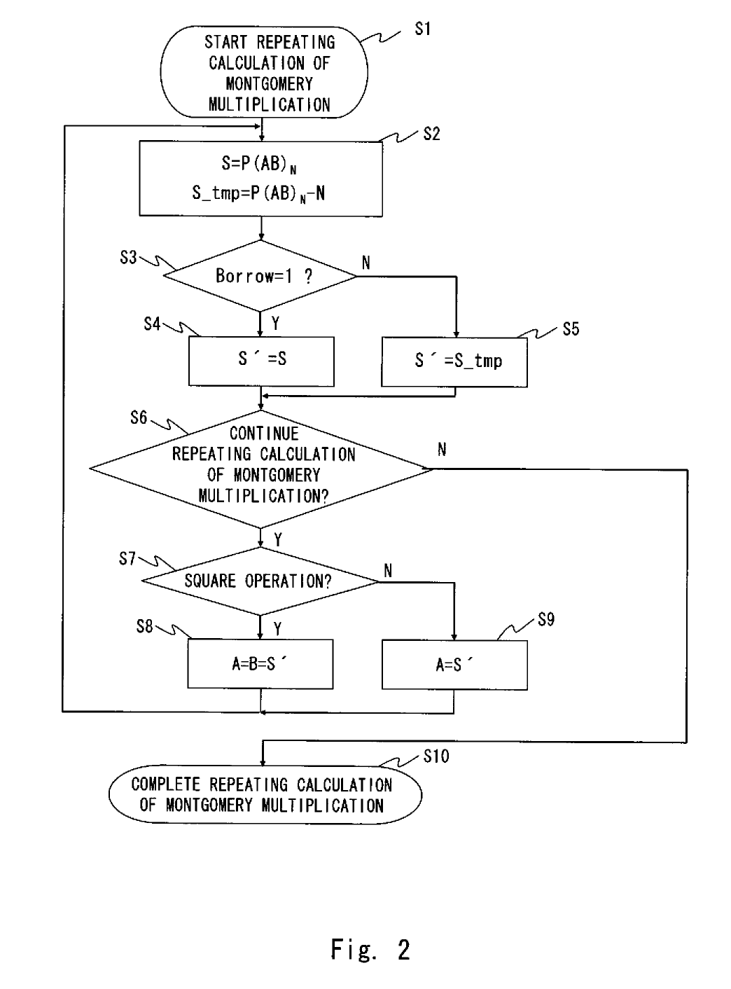

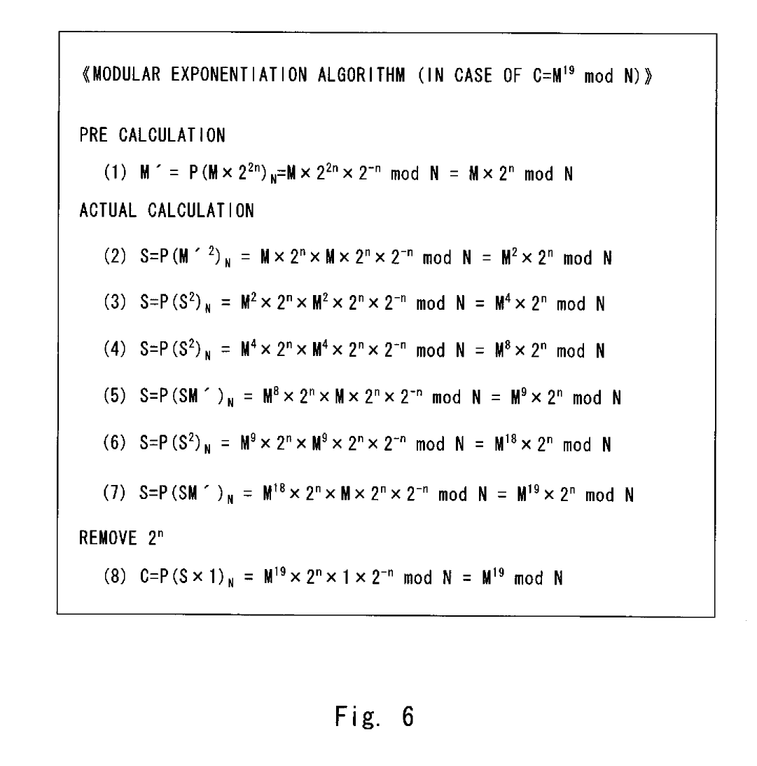

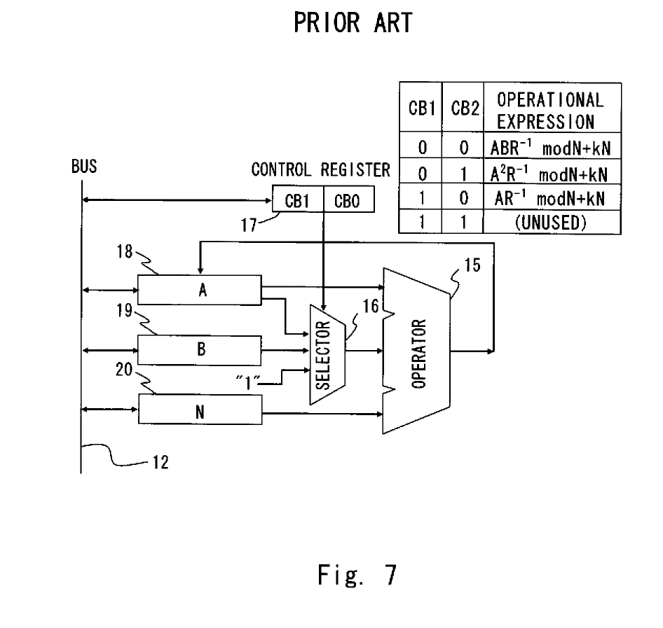

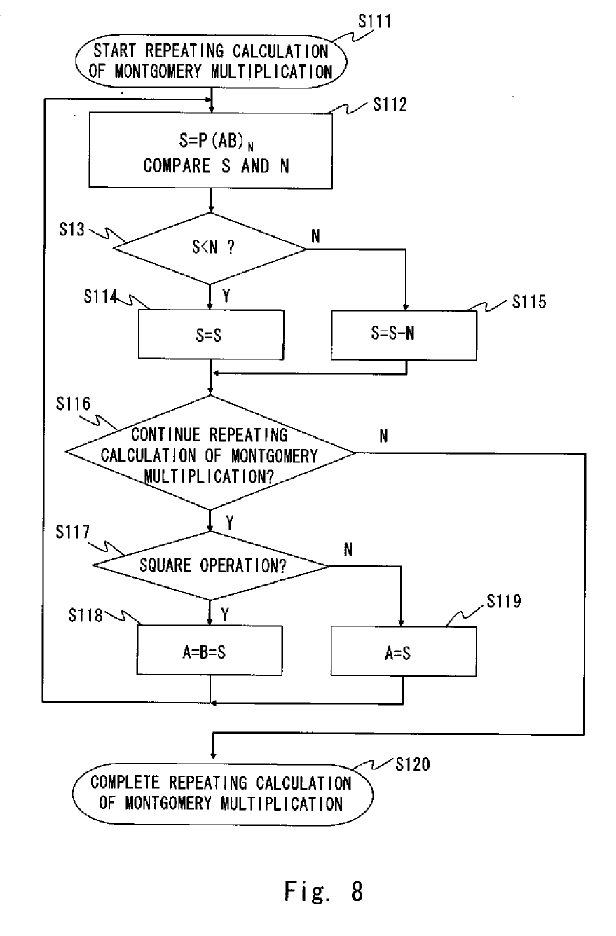

This exemplary embodiment of the present invention processes a Montgomery multiplication by the modular operation apparatus 10 of FIG. 1, and processes a modular exponentiation operation by repeatedly calculating Montgomery multiplication according to the modular exponentiation operation algorithm of FIG. 6. That is, the modular operation apparatus 10 illustrated in FIG. 1 calculates M′ using (1) of the modular exponentiation operation algorithm of FIG. 6, uses M′ as initial values of A and B, which are inputs of the operator 1, and repeats the Montgomery multiplication process flow illustrated in FIG. 2 according to an exponent e, which is decomposed as in (2) to (7) in the modular exponentiation operation algorithm of FIG. 6. Lastly, the modular operation apparatus 10 removes 2ⁿ in (8) of the modular exponentiation operation algorithm of FIG. 6, so as to process the modular exponentiation operation.

The abovementioned Montgomery multiplication process flow is explained hereinafter. FIG. 2 illustrates the process flow of the Montgomery multiplication according to this exemplary embodiment.

First, a repeated calculation of a Montgomery multiplication of S1 is started according to the decomposed exponent. However, it is A=B=M′ as described above.

In the following S2, the Montgomery multiplication is performed and a reduction is also forced. Then, the operation result S of the Montgomery multiplication and the reduction result S_tmp are stored at the same time.

Next, in S3, it is confirmed whether a borrow is generated (Borrow=1) or not (Borrow=0) when the abovementioned reduction result S_tmp is calculated. If a borrow is generated (Borrow=1), that is if the operation result S of the Montgomery multiplication is smaller than the divisor N, a normal result S′ of the Montgomery multiplication is the operation result S of the Montgomery multiplication performed in S2, as indicated in S4. Further, if a borrow is not generated (Borrow=0), the normal result S′ of the Montgomery multiplication is the reduction result S_tmp performed in S2, as indicated in S5.

Next, in S6, it is determined whether to continue repeating the Montgomery multiplication according to the decomposed exponent. If all the repeating Montgomery multiplications are completed according to the decomposed exponent, the process proceeds to S10, which is a completion of the repeated calculation of the Montgomery multiplication. If the Montgomery multiplication is continued to repeat, in S7, the decomposed exponent is referred to determine whether the next Montgomery multiplication is a multiplication or a square operation. If the next Montgomery multiplication is a square operation, it is A=B=S′ in S8, and, in the case of multiplication, it is A=S′ in S9. Then in S2, the Montgomery multiplication and the reduction are performed again.

That is, the modular operation method according to this exemplary embodiment firstly performs a Montgomery multiplication based on the multiplicand, the multiplier, and the divisor.

Next, the operation result of the Montgomery multiplication is stored as the first multiplicand.

The divisor is subtracted from the operation result of the Montgomery multiplication, and the subtracted result is stored as the second multiplicand.

Then, either the value of the first multiplicand register or the value of the second multiplicand register is selected according to the operation result of the Montgomery multiplication and the comparison result of the divisor.

The Montgomery multiplication is performed again according to the selected multiplicand, multiplier and divisor.

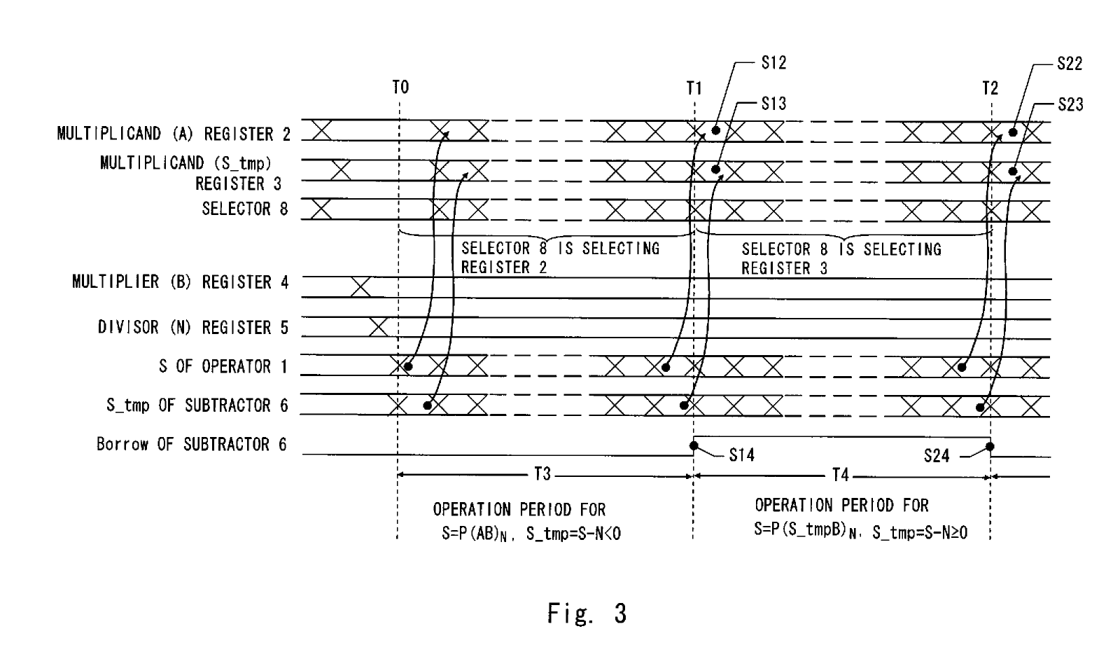

Based on the abovementioned Montgomery multiplication process flow of FIG. 2, an operation of the modular operation apparatus 10 according to this exemplary embodiment for the Montgomery multiplication is described hereinafter with reference to FIG. 1. Further, FIG. 3 is a timing chart for various signals in FIG. 1 in the Montgomery multiplication of this exemplary embodiment. T0 is the Montgomery multiplication start timing of the operator 1. T1 is the Montgomery multiplication completion timing of the operator 1. Further, T1 is the next Montgomery multiplication start timing of the operator 1, and T2 is the Montgomery multiplication completion timing of the operator 1. Timings of various signals in the Montgomery multiplication according to this exemplary embodiment are described as appropriate together with the explanation of FIG. 1.

In FIG. 1, an output of the multiplicand A register 2 or an output of the multiplicand S_tmp register 3 is input to an input A of the operator 1 in a time-sharing manner by each bit length from the lower bit side. Further, an output of the multiplier B register 4 is input to an input B, and an output of the divisor N register 5 is input to an input N. Moreover, the operator 1 performs the operation of S=P(AB)_{N} before the reduction from the lower bit side in a time-sharing manner by each bit length, and outputs an operation result S similarly from the lower bit side in a time-sharing manner by each bit length. The timing of the operation result S is indicated as S in the operator 1 of FIG. 3.

The subtractor 6, that is composed of a combinational circuit, performs a reduction of S, which is the operation result output from the operator 1 in a time-sharing manner, and an input N by S-N in a time-sharing manner, and outputs the subtracted result S_tmp from the lower bit side in a time-sharing manner by each bit length. The timing of the subtraction result S_tmp is indicated as S_tmp in the subtractor 6 in FIG. 3.

The operation result S output from the operator 1 in a time-sharing manner is stored as needed to the multiplicand A register 2. At the same time, the subtraction result S_tmp output from the subtractor 6 in a time-sharing manner is stored to the multiplicand S_tmp register 3 as needed. Timings of the multiplicand A register 2 and the multiplicand S_tmp register 3 are illustrated in the multiplicand A register 2 and the multiplicand S_tmp register 3 of FIG. 3.

When all the time-sharing operations are completed in the operator 1 and the subtractor 6 that output the operation results in a time-sharing manner, all bits of the operation result S are stored to the multiplicand A register 2. At the same time, all bits of the reduction result are stored to the multiplicand S_tmp register 3. At the same time, the subtractor 6 generates the borrow signal 7 that indicates whether a borrow is generated or not in the operation result of S−N eventually. The borrow signal 7 is “1” if a borrow is generated, and the borrow signal 7 is “0” if a borrow is not generated.

S12 and S22 of FIG. 3 indicate the state in which all bits of the operation result S are stored to the abovementioned multiplicand A register 2. Further, S13 and S23 of FIG. 3 indicate the state in which all bits of the reduction result are stored to the abovementioned multiplicand S_tmp register 3. Furthermore, S14 and S24 of FIG. 3 indicate the state of the abovementioned borrow signal.

If the borrow signal 7 is “1”, it means that the Montgomery multiplication did not require a reduction and a normal operation result is held in the multiplicand A register 2. If the borrow signal 7 is “0”, it means that the Montgomery multiplication required a reduction and a normal operation result is held in the multiplicand S_tmp register 3.

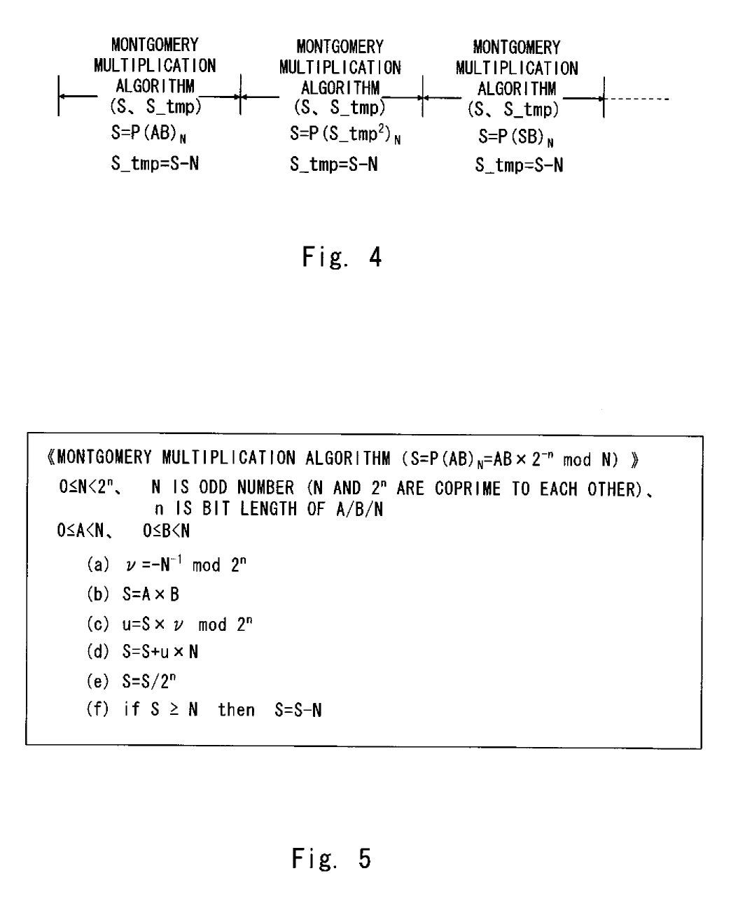

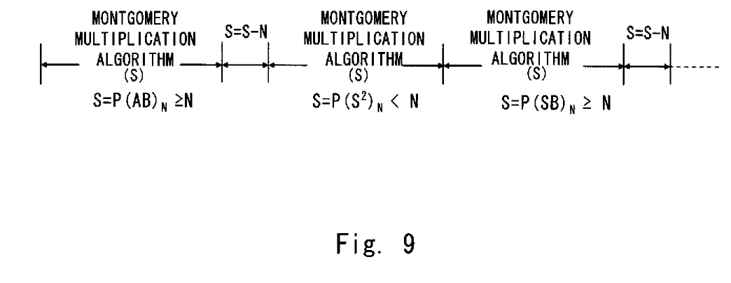

By the way, as illustrated in the modular exponentiation operation algorithm of FIG. 6, the Montgomery multiplication is repeatedly calculated for the modular exponentiation operation. Therefore, by the operation to force a reduction during the abovementioned Montgomery multiplication period, no reduction (the reduction period S−N in FIG. 9) exists in the modular exponential operation period after completing the Montgomery multiplication. FIG. 4 is a timing chart illustrating a part of the processing operation of the modular exponentiation operation according to this exemplary embodiment. It can be seen from FIG. 4 that no reduction exists after completing the Montgomery multiplication.

The modular operation apparatus 10 of this exemplary embodiment forces a reduction during the calculation of the Montgomery multiplication and holds both of the values before and after the reduction. This enables the S−N reduction period, which is visible in the related art of FIG. 9, to be invisible apparently as illustrated in FIG. 4. By making the reduction period invisible, it is difficult to detect whether a reduction exists or not from the difference of processing time using timing analysis, which is one method of the side channel attacks. Therefore, it is unable to distinguish whether a reduction exists or not and thereby enabling to make it difficult to guess a secret key. That is, this improves the tamper resistance to the side channel attack.

Further, even when the result of a Montgomery multiplication does not require a reduction, by performing a dummy reduction and simply performing a reduction after completing each Montgomery multiplication, the same effect as this exemplary embodiment of the present invention can be achieved. However, if the multiplier, the multiplicand, and the divisor are multiple-precision integers, and a dummy reduction is performed for an RSA™ method that performs a Montgomery multiplication for 1500 or 3000 times, for example, it is unavoidable that the processing performance of the entire modular exponentiation operation is reduced.

The present invention according to this exemplary embodiment does not need the abovementioned dummy process, which reduces the processing performance, to improve the tamper resistance. Further, the amount of process data can be reduced by the cutdown of the reduction period after a Montgomery multiplication and thus improving the processing performance of the modular exponentiation operation.

As described above, the modular operation apparatus according to this exemplary embodiment forces a reduction during the calculation of the Montgomery multiplication and holds the result of the forced reduction and the result before reduction to each of storage apparatuses. Then, the modular operation apparatus determines which is a normal operation result according to the value of the borrow signal generated according to the reduction result.

By forcing a reduction during the operation period not after completing the Montgomery multiplication, the reduction period is made invisible apparently, and this disables to easily guess whether the reduction is performed or not by the timing analysis.

The present invention is not limited to the above exemplary embodiment, and may be modified within the scope of the present invention.

The above exemplary embodiment explained the case of applying the binary exponentiation to the decomposition method of e. However the same effect as the abovementioned exemplary embodiment can be achieved by other decomposition method of e.

By applying an efficient decomposition method of e that enables to reduce the count of Montgomery multiplication, it is possible to keep the effects of the abovementioned exemplary embodiment of the present invention and also to improve the processing performance of a modular exponentiation operation.

Further, the abovementioned exemplary embodiment explained a means to hold the multiplier, the multiplicand, the divisor, and the Montgomery multiplication result by a register. However it is not limited to the register but can be a circuit or an apparatus that can hold them.

Accordingly, the modular operation apparatus of this exemplary embodiment disables to detect whether a reduction exists or not from the difference of processing time in the timing analysis, which is one of the method for the side channel attack, thus making it difficult to guess a secret key and improving the tamper resistance to the side channel attack.

Further, it is possible to improve the tamper resistance without inserting a dummy reduction process, that could cause to reduce the processing performance.

Cutting out the reduction period after Montgomery multiplication enables to reduce the processing time and thus improve the processing performance of the modular exponentiation operation.

As the public key cryptosystem is based on the modular exponentiation operation, the exemplary embodiment of the present invention can be applied to all the public key cryptosystems that require modular an exponentiation operation such as elliptic curve cryptosystem and digital signature.

Moreover, by applying the present invention to an information processing system that requires a Montgomery multiplication, not only to a cryptosystem, the amount of process data can be reduced and thus enabling to improve the processing performance of a modular exponentiation operation.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A modular operation apparatus comprising:
an operator that carries out a Montgomery multiplication according to one of a first multiplicand and a second multiplicand, a multiplier, and a divisor;
a first multiplicand register that stores an operation result of the Montgomery multiplication as the first multiplicand;
a subtractor that subtracts the divisor from the operation result of the Montgomery multiplication;
a second multiplicand register that stores a subtraction result of the subtractor as the second multiplicand; and
a selector that outputs one of a value of the first multiplicand register and a value of the second multiplicand register according to a comparison result between the operation result of the Montgomery multiplication and the divisor.

2. The modular operation apparatus according to claim 1, wherein
the subtractor generates a borrow signal according to the comparison result between the operation result of the Montgomery multiplication and the divisor, and outputs the borrow signal to the selector, and
the selector outputs one of the value of the first multiplicand register and the value of the second multiplicand register to the operator according to the borrow signal.

3. The modular operation apparatus according to claim 1, wherein the selector outputs the value of the first multiplicand register to the operator if the operation result of the Montgomery multiplication is smaller than the divisor.

4. The modular operation apparatus according to claim 1, wherein
the first multiplicand register, the second multiplicand register, a multiplier register that stores the multiplier, and a divisor register that stores the divisor are connected to a data bus, and
the modular operation apparatus writes and reads data via the data bus.

5. The modular operation apparatus according to claim 1, wherein if the first multiplicand is A, the second multiplicand is S_tmp, the multiplier is B, and the divisor is N,
the operator that carries out the Montgomery multiplication carries out an operation of S=P(AB)_{N},
the first multiplicand register stores the operation result S of the Montgomery multiplication as the first multiplicand,
the subtractor carries out an operation of S-N,
the second multiplicand register stores a subtraction result S-N of the subtractor,
the selector outputs one of a value of the operation result S of the Montgomery multiplication and a value of the subtraction result S-N of the subtractor according to the comparison result between the operation result S of the Montgomery multiplication and the divisor N.

6. A method of modular operation comprising:
carrying out a Montgomery multiplication according to a multiplicand, a multiplier, and a divisor;
storing an operation result of the Montgomery multiplication as a first multiplicand;
subtracting the divisor from the operation result of the Montgomery multiplication, and storing a subtraction result as a second multiplicand;
selecting one of a value of the first multiplicand register and a value of the second multiplicand register according to a comparison result between the operation result of the Montgomery multiplication and the divisor; and
carrying out a Montgomery multiplicand according to the selected multiplicand, the multiplier, and the divisor.

7. The method of modular operation according to claim 6, wherein selecting the value of the first multiplicand if the operation result of the Montgomery multiplicand is smaller than the divisor.

8. The method of modular operation according to claim 6, wherein if the multiplicand is A, the multiplier is B, and the divisor is N,
carrying out a Montgomery multiplication of S=P(AB)_{N};
storing S as the first multiplicand, the S being the operation result of the Montgomery multiplication;
subtracting the divisor from the operation result S of the Montgomery multiplication, and storing a subtraction result S-N as the second multiplicand;
selecting one of the value S of the first multiplicand register and the value S-N of the second multiplicand register according to the comparison result between the operation result S of the Montgomery multiplication and the divisor N; and
carrying out a Montgomery multiplication according to the selected multiplicand, the multiplier B, and the divisor N.
